(19) United States
(12) Patent Application Publication
(10) Pub. No.: US 2026/0280213 A1
(43) Pub. Date: Sep. 17, 2026

(54) Method for Automatically Finishing a Cable, Cable Processing Center, Trajectory Detection Device and Inspection System

(71) Applicant: Zoller & Fröhlich GmbH, Wangen im Allgau (DE)

(72) Inventors: Steffen Hartinger, Wangen (DE); Bernhard Graf, Wangen (DE); Florian Jocham, Wangen (DE); Christoph Fröhlich, Wangen (DE)

(21) Appl. No.: 19/469,924

(22) PCT Filed: Mar. 27, 2024
(86) PCT No.: PCT/EP2024/058359

§ 371 Date: Sep. 26, 2025

(30) Foreign Application Priority Data
Mar. 27, 2023 (DE) 10 2023 107 727.9

(51) Int. Cl. H01R 43/052; H01R 43/05; H01R 43/28

(52) U.S. Cl. CPC H01R 43/052; H01R 43/05; H01R 43/28

(57) ABSTRACT

The invention relates to a method for automatically finishing a wire, a wire processing center, a trajectory detection device and an inspection system for a wire processing center of this type.

### BACKGROUND OF THE INVENTION

### Field of the Invention

The invention relates to a method for automatically processing a wire, a wire processing center, in particular for carrying out this method, as well as a trajectory detection device and an inspection system for such a wire processing center.

### Description of the Related Art

With such a center, wires can be fed, cut to length, provided with a marking, and crimped with a contact element, for example a wire-end ferrule. The processed wires are then usually bundled and stored in a storage configuration. Such a center is disclosed, for example, in U.S. Pat. No. 8,442,664 B1. The actual wire assembly is performed by a unit that is configured as a special machine and enables the work steps described above. Such a unit has an extremely complex structure and can only be adapted to different production tasks with great effort. Furthermore, such a special machine is relatively expensive and requires a large installation space within the production line.

A similar solution is described in EP 0 132 092 A1. This discloses a device for producing wire harnesses in which cables/wires are fed via a wire feeding device and contact elements are fed via another feeding apparatus. The wires are cut to length using a cutting device and are crimped with contact elements using a crimping machine. The assembled wires are then transported via a measuring and feeding device for further processing. A crimping head and a forming tool that holds the contact element during the crimping process are configured as separate units, wherein a cutting device is integrated in the unit that accommodates the crimping head. This device has the same disadvantages as the special machine described above.

In U.S. Pat. No. 6,662,444 B2, a method and a device are disclosed, wherein an end portion of a wire can either be crimped with a contact element and/or another end portion may be crimped with a connector. The device used for this has a wire feed device via which wires are cut to length and the corresponding end portions are stripped for contacting with a crimp terminal or the connector. Cutting to length is carried out using a cutter, the cut-to-length cables/wires are then bent into a U-shape and positioned at an intermediate storage device, from where the wires are fed to another device for pressing/crimping.

This solution is also a special machine that is configured specifically for the intended purpose.

Document U.S. Pat. No. 5,878,469 A relates to a device for processing wire harnesses, which has a cutting device, a stripper, a type of crimping unit and a device for connecting to a connector.

This solution is also configured as a special machine and cannot be adapted to other production tasks, or only with considerable effort.

A more flexible solution is to provide modular units instead of a special machine, on which the individual processing steps (cutting to length, marking, stripping, crimping, bundling) are then carried out by a machine operator. Crimping is carried out using a crimping machine, such as that known from patent specification DE 44 40 835 C1 of the applicant, and is used, for example, to crimp wire-end ferrules with a stripped wire end. In the known solution, these wire-end ferrules are rolled onto a drum magazine in the form of belt-strips and are conveyed from this via a transport unit to a crimping head. Alternatively, the wire-end ferrules or contact elements may also be held individually in a storage unit and may then be conveyed to the crimping head in a defined position via a suitable feeding apparatus. Such a feeding apparatus is described, for example, in DE 198 31 588 A1.

In the known solutions, the wire-end ferrule to be crimped is placed on the stripped wire end via a holding unit and is then crimped via the crimping head. The wire end can be stripped either externally or via a stripping head integrated into the crimping machine.

The modular units described above are configured as standalone units, which are each equipped with their own drive units, for example, and are therefore usually operated independently of other processing units.

The configuration of a transport unit for conveying the wire-end ferrules arranged on a webbing or of other electrical components is described, for example, in document G 93 08 266.5 of the applicant. A similar transport unit is also disclosed in DE 197 14 964 C1.

The US patent application US 2010/0293 780 A1 shows a movable unit via which contact elements to be processed can be positioned in the area of a stationary wire assembly apparatus configured as a special machine.

In series production, it is necessary to press different wire cross-sections and electrical components/contact elements together and then to install them in a subsequent assembly step, for example when assembling a switch cabinet. In principle, there are two options for this: in one variant, the crimping machine is converted for crimping different wire cross-sections and/or contact elements (wire-end ferrules), or several crimping machines are provided for processing the different wire cross-sections/contact elements. The former solution requires long set-up times and considerable manpower. This disadvantage is overcome in the latter solution with a large number of crimping machines—but the investment costs are considerable.

In document DE 10 2004 057 818 B3, a machine (configured as a stripper and crimper) is disclosed with which different wire cross-sections and wire-end ferrules can be processed. A drum magazine and an associated crimping apparatus are provided for each type of wire-end ferrule, to which a common drive is assigned, which can optionally be brought into operative engagement with one of the crimping apparatuses. Such a solution requires a great deal of technical equipment, since a large number of crimping apparatuses has to be provided and controlled.

DE 10 2015 119 217 A1, which originates from the applicant, shows a crimping machine that eliminates the disadvantages mentioned above. This crimping machine has a storage configuration with several drum magazines, to which a common transport unit and a common crimping head are assigned, so that the equipment-related effort is significantly reduced compared to the solution described above.

DE 10 2017 118 968 of the applicant discloses a crimping machine in which a contact element to be crimped is guided directly into the operating range of a stripping machine or crimping head without the interposition of a feeder device or the like. In this known solution, the contact elements are preferably stored in drum magazines, so that the crimping machine is accordingly configured with a separating device.

DE 10 2015 102 060 A1, which also originates from the applicant, shows a crimping machine in which different wire-end ferrules are stored in a storage configuration with several drum magazines. A transport unit is assigned to each of these drum magazines, via which the preselected wire-end ferrule is transported to a transfer position. The wire-end ferrule cut off there is then guided to a common crimping head via a shuttle.

This crimping machine is characterized by high productivity. However, a certain disadvantage is seen in the fact that the required shuttle has a comparatively complex configuration and requires corresponding installation space, and that stripping is not possible.

Due to the high proportion of manual work, the demands on machine operators during assembly and, in particular, during the subsequent laying of the wires in the switch cabinet are relatively high, wherein errors cannot be ruled out.

In WO 2019/211 490 A1 of the applicant, a modular wire processing center is proposed to overcome the disadvantages of the concepts described above, in which the processing modules are arranged on a mobile platform.

DE 10 2018 131 441 A1, which originates from the applicant, describes a wire processing center with a cutting machine that is configured to process multiple wire cross-sections or wire types. A multiple feed unit is provided, wherein a wire to be processed is aligned with respect to the feed or transport device of the automatic cutting machine via a control device of the wire processing center. In an embodiment of DE 10 2018 131 444 A1, the wires cut to length by the automatic cutting machine are fed by a robot to further processing units, for example a stripping machine/automatic crimping machine and a marking system (printer) or a wire removal unit.

A similar wire processing center is described in WO 2022/079 215 A1 of the applicant, wherein the processing units are arranged on or around a rotary table.

### SUMMARY

When using such wire processing centers, it was found that despite the extensive automation, manual intervention is still required to ensure the quality of the wire assembly.

In contrast, the object of the invention is to create a method for automatic assembling of wires and a wire processing center, in particular for carrying out such a method, via which automated production is made possible without any loss of quality.

This object is solved with regard to the method by the combination of features of claim 1 and with regard to the wire processing center by the features of the independent claim 3. Part of the solution according to the invention are also a trajectory detection device according to claim 8 and an inspection system according to claim 10, which are part of the wire processing center or are used in the method according to the invention in order to ensure the quality of the assembly.

Advantageous further developments of the invention are the subject matter of the dependent claims.

The method according to the invention for automatically assembling a wire uses a wire processing center which is controlled via a central control unit and which has at least one processing unit to which the wire is automatically fed via a handling device, in particular a robot. According to the invention, it is provided that this wire is fixed via a gripper of the handling device in such a way that a wire end protrudes from the gripper. In a subsequent step, the trajectory of the wire end protruding from the gripper is detected in relation to the gripper via a trajectory detection device. The term ‘trajectory’ refers to the bend resulting from the low bending stiffness of the wire, with which the wire end deviates from an ideal position/ideal course of a rigid wire end. This trajectory, i.e. the deviation of the bend/geometry of the wire end from the ideal value (rigid, undeformed wire end) is then reported to the central control unit, whereupon it drives the gripper in such a way that the deviation from the ideal course is taken into account when the wire end is fed to the next processing unit via the gripper. In this way, it is possible, for example, to position the wire end precisely in relation to the comparatively narrow insertion opening of the stripping/crimping machine when feeding the wire end to a stripping unit/crimping unit, so that a collision of the wire end with peripheral areas of the insertion opening is ruled out.

This procedure eliminates the need for manual inspection and, accordingly, significantly reduces rejects compared to conventional solutions.

According to the invention, it is preferred if, after processing in a processing unit, the wire is fed via the gripper to an inspection system for checking the wire assembly and then in turn is fed to another station via the gripper depending on the result of this check.

The inspection system and the trajectory detection device may also be configured as a unit, so that trajectory determination and quality control take place in this unit, thus saving installation space.

The wire processing center according to the invention—also called Wire Processing Center (WPC)—has several processing units, such as a cutting automat, and/or a stripping machine, and/or a crimping machine, and/or a grommet station, and/or a marking station, and/or a storage unit, wherein the wire to be assembled is transported via a handling device configured with a gripper, wherein a trajectory detection device for detecting the aforementioned trajectory of the wire end with respect to the gripper is arranged between two processing stations, so that exact positioning of the wire end is ensured when approaching the following processing unit.

It is particularly preferred if the wire is cut to length in a cutting automat and then picked up by the gripper and preferably fed to a stripping machine and/or crimping machine.

After the latter, an inspection system is preferably provided for automatically checking the quality of the wire assembly, for example the crimping.

Furthermore, in one embodiment of the invention, the wire processing center according to the invention has a storage unit for depositing the assembled wires that correspond to the specifications and a special storage unit for depositing the wires that do not correspond to the specifications, wherein the wires are again fed via the handling device.

In a particularly preferred embodiment of the invention, the handling device is configured with a multi-axis robot which has two grippers, each of which grips a wire end and which are adjustable depending on the wire length and wire geometry.

A trajectory detection device used in the wire processing center according to the invention preferably has a housing with a feed opening for the wire end, wherein lighting and a sensor system, in particular a camera arrangement for trajectory detection, are provided in the interior of the housing, wherein the detected data, i.e. the detected trajectory (deviation from the ideal, straight line), is forwarded via a transmission unit to the control unit for driving the gripper as a function of the detected trajectory.

In a specific embodiment of the invention, the sensor system is configured with two cameras angled toward each other. One camera may also be positioned at an axial distance from the wire end for detecting the trajectory.

An automatic inspection system used in the wire processing center also has a housing with a feed opening for the wire end, wherein lighting and a sensor system, in particular a camera arrangement for quality inspection of the wire, are arranged in the interior of the housing. The detected quality data is in turn reported to the control unit via a transmission unit, so that the control unit controls the gripper depending on this quality data.

The quality inspection is particularly precise if the camera arrangement has three cameras located on a common pitch circle which, so to speak, surrounds the wire end.

According to the invention, it is preferred if the cameras or the sensors are orientated with respect to the insertion opening, or more precisely, with respect to the wire end fed through the insertion opening.

The lighting of the trajectory detection device and/or the inspection system is preferably configured to illuminate the wire end over a wide area.

Access to the trajectory detection device and the inspection system is particularly easy if the insertion opening is configured on the front side, so that the feed takes place in a horizontal direction.

The space required by these units is minimal if they are recessed in sections into a base plate, for example a table top of the wire processing center.

### BRIEF DESCRIPTION OF THE DRAWINGS

Preferred embodiments of the invention are explained in more detail below with reference to schematic drawings. The following is shown:

FIG. 1 shows a three-dimensional overview representation of a wire processing center according to the invention;

FIG. 2 shows a cutting automat of the wire processing center (WPC) according to FIG. 1;

FIGS. 3, 4 show representations of a trajectory detection device of the WPC according to FIG. 1;

FIG. 5 shows an example of a trajectory path of a wire;

FIG. 6 shows a crimping machine of the WPC according to FIG. 1;

FIGS. 7, 8 show representations of an inspection system of the WPC according to FIG. 1;

FIG. 9 shows an illustration of a faulty wire detected by the inspection system;

FIG. 10 shows a storage unit of the WPC configured as a bundle system according to FIG. 1;

FIG. 11 shows a robot with two grippers of the WPC according to FIG. 1, and

FIG. 12 shows steps of the method according to the invention for the automatic assembling of a wire.

### DETAILED DESCRIPTION OF THE PREFERRED EMBODIMENTS

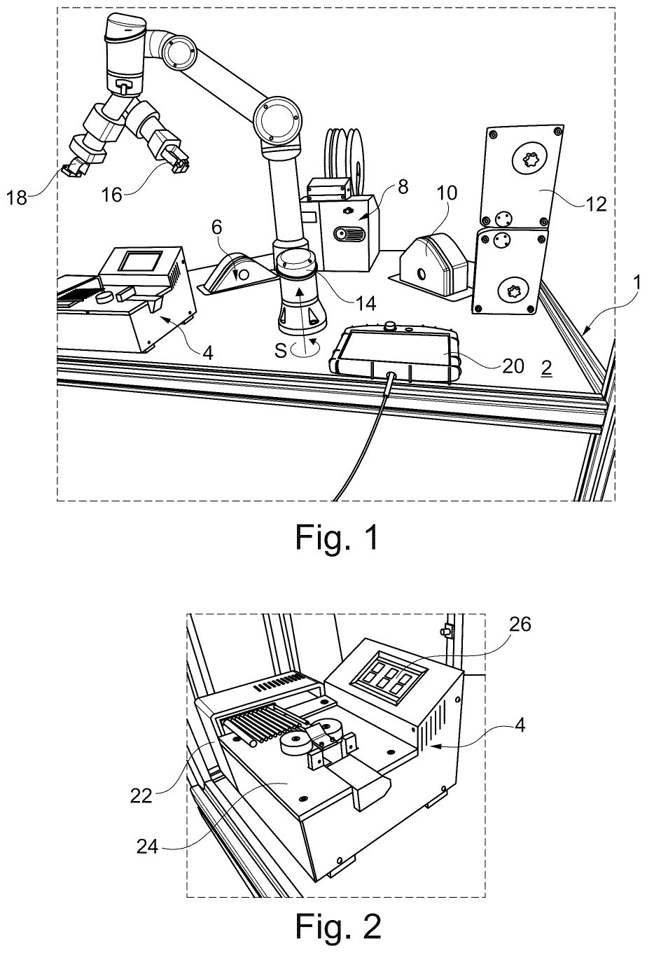

The basic structure of a wire processing center according to the invention, hereinafter referred to as WPC (Wire Processing Center) 1, is shown in FIG. 1. Accordingly, this WPC 1—similar to the solution disclosed in DE 10 2018 131 444 A1—is positioned stationary on a table or mobile on a workshop cart, wherein the components are positioned on a base plate or table top 2. As shown in FIG. 1, the WPC 1 has several processing units, wherein in the embodiment shown in FIG. 1 a cutting automat 4, a trajectory detection device—hereinafter referred to as BCS (Bending Control System) 6, a crimping machine 8, an inspection system—hereinafter referred to as QCS (Quality Control System) 10, and a storage unit 12 configured as a bundle system, in which the assembled wires can be stored, are provided.

The wires to be assembled are fed/moved between the aforementioned processing units by a multi-axis robot 14, which is equipped with two grippers 16, 18. The robot 14 can be driven in such a way that all processing units can be reached with a minimum travel distance. In the embodiment shown, the processing units described are positioned approximately in a semicircle around the vertical swivel axis S of the robot 14. The robot 14 and the described processing units are driven by a central control unit 20. The cutting automat 4 and the crimping machine 8 are standard devices of the applicant, which can also be used as stand-alone machines and whose basic structure is in principle known on the market, so that no detailed description of these units is necessary.

FIG. 2 shows a single representation of the cutting automat 4. This consists of a multiple feed unit 22 and a cutting machine 24. Specifically, the multiple feed unit 22 is the applicant's Z+F EVOFEED® model, with which up to twelve cables can be fed, so that sequential processing of complex projects is possible. The actual cutting to length is carried out, for example, via the cutting machine 24 of the type Z+F EVOCUT®, in which the wires to be cut to length and fed by the multiple feed unit 22, are guided in a horizontal direction and are cut to length according to the specifications of the control unit 20. The respective cutting process can be controlled decentrally on the cutting automat 4 using a display 26 or centrally on the display of the control unit 20.

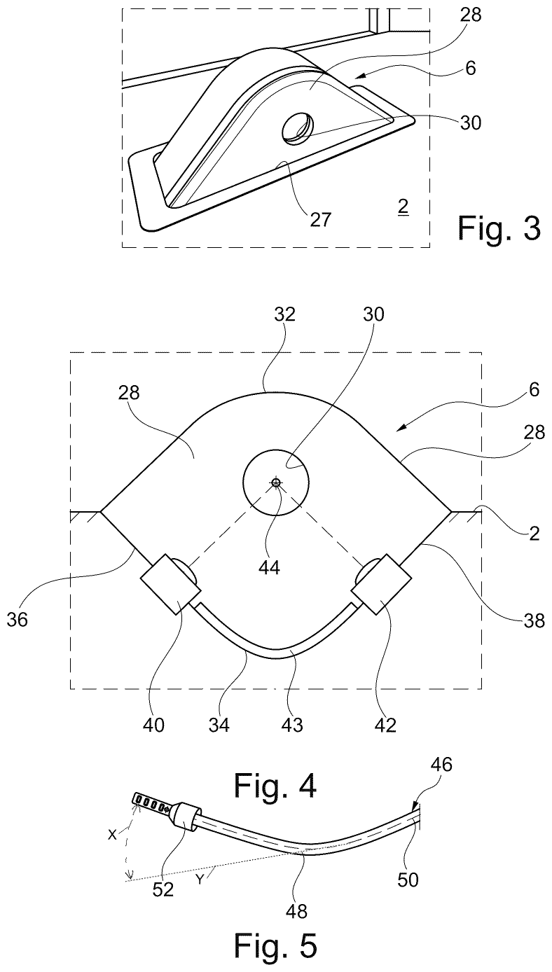

FIG. 3 shows an external view of the BCS 6. Accordingly, it is partially recessed into a recess 27 of the table top 2, so that the installation space is minimal. The BCS 6 has a housing 28 in which an insertion opening 30 is formed at the end face, opening in the horizontal direction (i.e. parallel to the surface of the table top 2), which can be inserted through the cut-to-length wire.

FIG. 4 shows a schematic representation of the structure of the BCS 6. The housing 28 sunk into the table top 2 can be seen, which, according to the representation in FIG. 4, is approximately rectangular or diamond-shaped with rounded apex areas 32, 34. As mentioned above, the insertion opening 30 opens at the end face into the interior of the housing 28. Two cameras 40, 42 are arranged in the region of the side surfaces 36, 38 of the housing 28 adjacent to the apex area 34, the lenses of which are orientated towards the horizontal axis 44, which corresponds to the feed axis of the wire, so that the cameras 40, 42 are accordingly focused on the inserted wire. The cameras 40, 42 are configured in such a way that the trajectory 50 of a wire, i.e. the deviation X of the course of the wire end 48 from the ideal Y (FIG. 5), can be detected. As explained above, the term ‘trajectory’ refers to the actual geometry of the wire end 48 fed through the insertion opening 30. In the case of a rigid wire (wire), this trajectory would be a straight line—however, due to the low bending stiffness of the wire 46, a bend occurs which is detected by the BCS 6. In principle, an additional camera may be mounted at an axial distance from the wire end.

Between the two cameras 40, 42, along the apex area 34, a flat lighting 43 is configured to illuminate the wire end 48, wherein this lighting 43 and the housing are configured in such a way that interference from light entering from outside is minimized.

As will be explained in more detail below, robot 14 is then driven as a function of the detected trajectory 50 of the wire end 48. In the illustration according to FIG. 5, the trajectory 50 of a wire 46 already crimped with a wire-end ferrule 52 was detected—of course, the trajectory 50 may also be detected before the crimping process. This is the case in the embodiment described below.

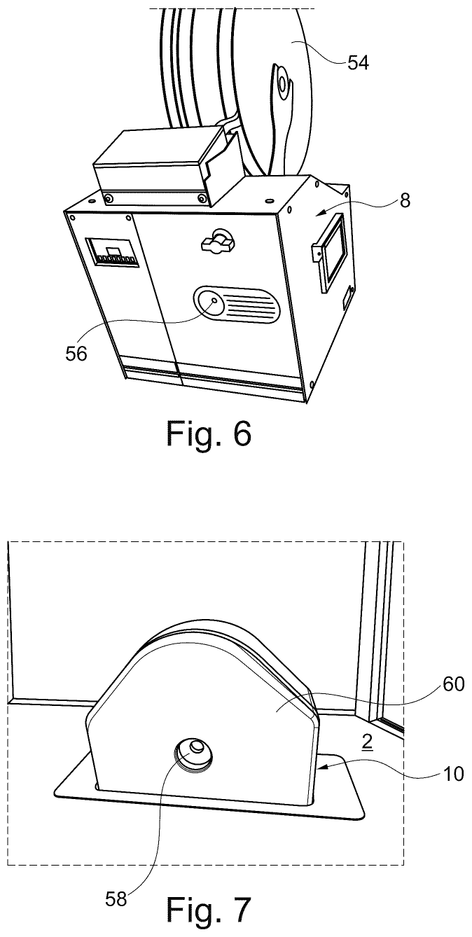

FIG. 6 shows a single illustration of the crimping machine 8, which is the Z+F UNIC GV® model, which enables different wire-end ferrules 52 or other contacts to be processed, which in turn are arranged on a reel magazine 54, so that different wire-end ferrules 52 or other contacts can be crimped without changing the magazine. The UNIC GV® model is a combination of a stripping machine and a crimping machine that enables the processing of five wire-end ferrules 52 reels with different cross-sections without converting or changing the reel magazines 54. This means that the crimping machine 8 strips the wire 46 and then crimps it to the selected wire-end ferrule 52. The wire 46 is fed via the robot 14 depending on the detected trajectory 50, wherein a precise alignment to the feed opening 56 of the crimping machine 8 is ensured even with complex trajectories 50.

FIG. 7 shows an individual representation of the QCS 10, which is used for quality control of the crimping. Similar to the BCS 6, the QCS 10 is also partially recessed into the table top 2. An insertion opening 58 is again provided at the front so that the crimped wire end 48 can be inserted horizontally into the interior of a housing 60.

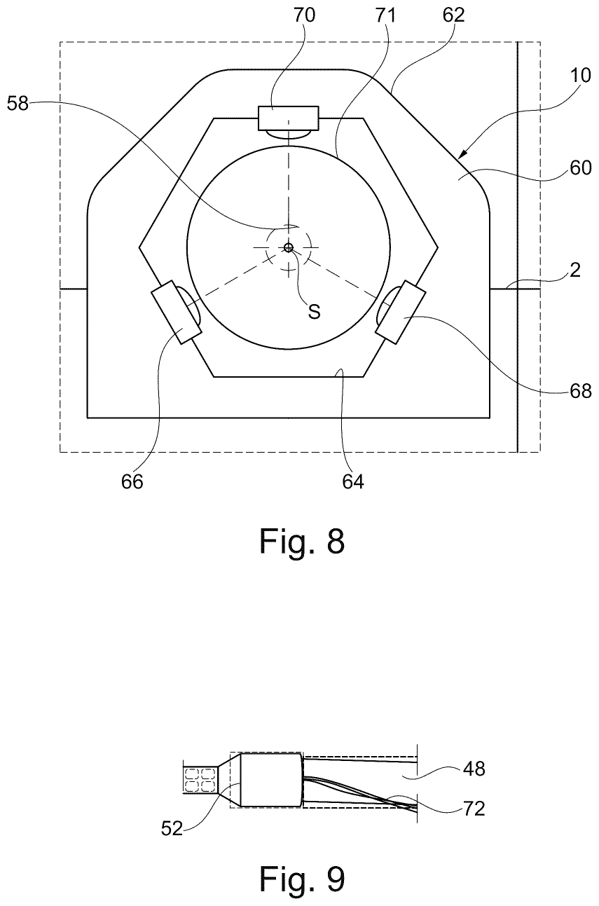

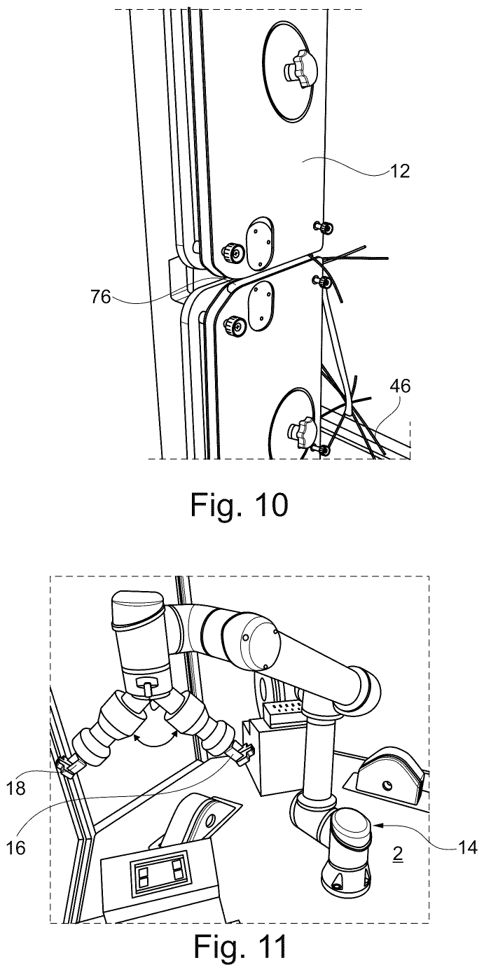

FIG. 8 shows a schematic cross-section of the QCS 10. The housing 60, which is partially sunk into the table top 2 and protrudes from the table top 2 with a roof-shaped beveled portion 62, can be seen. The insertion opening 58, through which the wire end 48 is fed, is formed in this area. A camera holder 64 is arranged inside the housing 60, on which cameras 66, 68, 70 lying on a common pitch circle are arranged, which are also orientated towards a horizontal axis S, along which the wire end 48 is inserted. In the embodiment shown, the camera holder 64 is configured, for example, as a hexagon, wherein the cameras 66, 68, 70 are held on the camera holder 64 with equal spacing. The cameras 66, 68, 70 and their positioning is selected in such a way that quality control of the wire assembling is possible.

In this embodiment, the interior of the housing 60 is also illuminated, wherein a ring-shaped lighting 71 positioned approximately concentrically to the insertion opening 58 is selected, so that precise illumination of the wire end 48, which is not influenced by external interference, is ensured. Instead of the ring-shaped lighting 71, several light sources, for example LEDs or the like, may of course also be provided. The wavelength of the light is selected for the lightings 43, 71 so that the geometry of the wire end 48 is illuminated in the best possible way, even with different materials.

As shown in FIG. 9, the QCS 10 may be used, for example, to reliably detect the quality of the crimping, a damaged wire-end ferrule 52, a missing wire-end ferrule 52, or a folded strand 72. The folded strand 72 in particular cannot be determined with sufficient accuracy by the machine operator using conventional methods. The use of the QCS 10 therefore represents a considerable improvement/assurance of production quality.

After this inspection using the QCS 10, the wire 46 can be fed to further processing steps, for example crimping of wire-end ferrules 52 with the other wire end 48, etc. After assembling the wire, the wire 46 is then deposited in a storage unit 12, which in the embodiment shown is configured as a bundle system in a manner known per se, in which the wires 46 released by the QCS 10 and corresponding to the specifications are positioned between two adhesive tapes, so that simple bundling is possible. Wires 46 that are assessed by the QCS 10 as not complying with the specifications are placed in a separate storage unit and are either disposed of or sent for reworking.

FIG. 11 shows the robot 14. This is configured as a multi-axis robot, wherein the axis arrangement is selected such that any processing unit on the table top 2 can be reached. In the specific embodiment, the robot 14 carries—as explained—the two adjustable grippers 16, 18, which are arranged approximately in a V-shape to each other in the illustration according to FIG. 11 and whose relative position can be changed in order to enable adaptation to different wire geometries and wire lengths. The grippers 16, 18 are adjusted in such a way that the cut-to-length wire 46 can be gripped in such a way that two wire ends 48 protrude beyond the grippers 16, 18 and can be fed to the processing units described above.

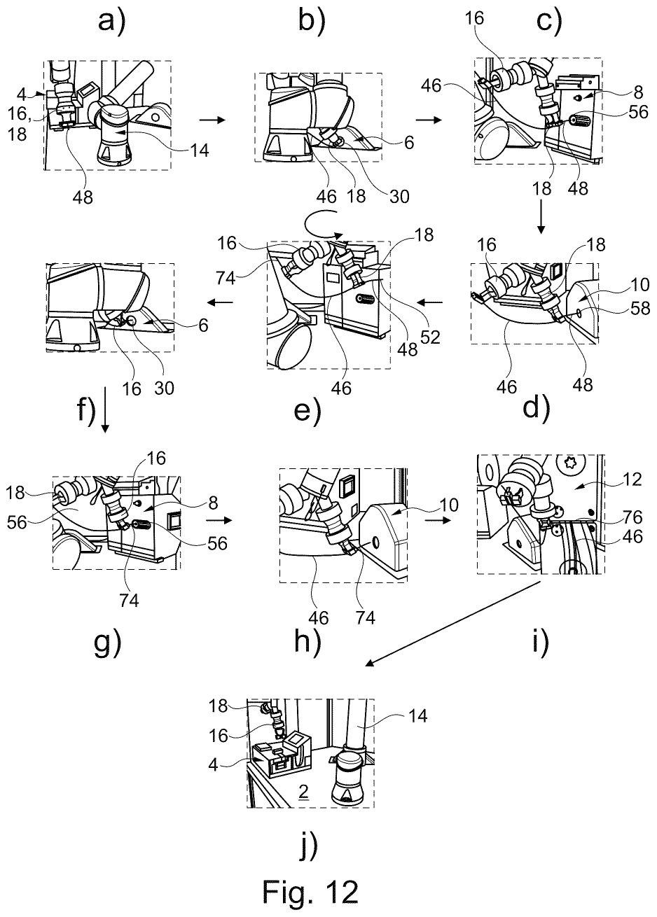

Details of the method according to the invention for automatically assembling a wire 46 are explained with reference to FIG. 12. This shows the individual process steps a) to j) of the wire assembly.

According to illustration 12a), the cut-to-length wire 46 is picked up by the grippers 16, 18 of the robot 14 at the cutting automat 4, wherein—as explained above—these grippers 16, 18 are set such that two wire ends 48, 74 protrude from the grippers 16, 18. According to step 12b), the wire 46 to be assembled is then guided with the wire end 48 into the insertion opening 30 of the BCS 6 and thus the trajectory 50 (see FIG. 5) is determined and, depending on this, according to step 12c) the wire end 48 is inserted into the feed opening 56 of the automatic crimping machine 8, so that the wire end 48 is stripped and crimped with a wire-end ferrule 52. According to step 12d), the wire end 48 provided with the wire-end ferrule 52 is then fed to the QCS 10 via its insertion opening 58, so that the quality of the crimping is reliably monitored.

In the event that this crimping meets the specifications and crimping of the other wire end 74 with a wire-end ferrule is desired, the two grippers 16, 18 are retracted and turned (step 12e). After this turning, the remaining wire end 74 is then fed to the BCS 6 in accordance with step 12f) in order to determine the trajectory 50 of this wire end 74. Depending on the trajectory 50, the wire end 74 is then inserted into the feed opening 56 of the automatic crimping machine 8 in accordance with step 12g), so that the wire end 74 is crimped to the corresponding wire-end ferrule 52 or to the other component. In the following step 12h), the wire end 74 with the wire-end ferrule 52 positioned on it is fed to the QCS 10 for quality control.

Wires 46 that meet the specifications are then deposited in the bundle system of the storage unit 12 according to step 12i), specifically positioned between the adhesive tapes 76. Wires 46 that do not correspond to the specifications are deposited by the robot 14 at a separate deposit position for recycling or reworking.

In the next process step 12j), the robot 14 with the grippers 16, 18 is again positioned in the area of the cutting automat 4 in order to pick up the next wire 46. This process is then repeated until assembling of the wire is completed.

Disclosed are a method for automatically assembling a wire, a wire processing center, a trajectory detection device and an inspection system for such a wire processing center.

1. A method for automatically processing a wire via a wire processing center which is controlled by a central control unit and which has at least one processing unit to which the wire is automatically fed via a handling device with a multi-axis robot, which has two grippers which are adjustable depending on a wire length and wire geometry, comprising the steps of
gripping the wire via the grippers of the handling device in such a way that respective one wire end protrudes from the gripper,
detecting the trajectory of the respective wire end in relation to the gripper via a trajectory detection device, by inserting the wire end through an insertion opening of a housing in the interior of which lighting and a sensor system are provided for trajectory tracking,
feeding the wire end to the processing unit as a function of the trajectory via the gripper, wherein wire is fed to an inspection system for automatic inspection of the wire assembly during or after the wire assembly via the gripper and then, depending on the result of the inspection, is fed to a further station, for example a storage unit, via the handling device.

2. A wire processing center, adapted for carrying out the method according to claim 1, with a central control unit, several processing units, such as a cutting automat, and/or a wire stripping machine, and/or a crimping machine, and/or a grommet station, and/or a marking station, and/or a storage unit wherein at least two of the processing units can be combined to form a processing automat, and a handling device configured with two grippers of a multi-axis robot, for moving the wire between the processing units, wherein the grippers are adjustable depending on a wire length and wire geometry, and wherein a trajectory detection device is provided in the working sequence between two of the processing units, wherein the trajectory detection device has a housing with an insertion opening for the wire end and in the interior of which lighting and a sensor system, in particular a camera arrangement for trajectory tracking, are provided, wherein the control unit is configured to control the grippers as a function of the detected data, and with an inspection system for automatically checking the quality of the wire assembly.

3. The wire processing center according to patent claim 2, with a cutting automat for cutting the wire to length, wherein the gripper is configured in such a way that the wire cut to length can be fed to a stripping machine and/or crimping machine.

4. The wire processing center according to claim 2, with a storage unit for depositing the assembled wires that correspond to the specifications and a special storage unit for depositing the wires that do not correspond to the specifications via the handling device.

5. The wire processing center according to one of claim 2, wherein two cameras are angled toward each other.

6. The wire processing center according to one of patent claim 2, wherein the inspection system is configured with a housing which has an insertion opening for the wire end and in the interior of which lighting and a sensor system, in particular a camera arrangement for quality inspection of the wire end, are accommodated, wherein the control unit is configured to control the robot as a function of the detected data.

7. The wire processing center according to claim 6, wherein the camera arrangement has three cameras located on a common pitch circle which surrounds the inserted wire end.

8. The wire processing center according to one of claim 2, wherein the cameras and the sensor system are orientated with respect to the insertion opening.

9. The wire processing center according to one of claim 2, wherein the lighting is configured to illuminate the wire end over a wide area.

10. The wire processing center according to one of the patent claim 2, wherein the insertion opening opens at the end face in the horizontal direction or in the vertical direction in the housing.

11. The wire processing center according to one of the patent claim 2, wherein the housing is recessed in sections into a table top or another base of a support frame.
